(19) United States
(12) Patent Application Publication
(10) Pub. No.: US 2008/0303437 A1
(43) Pub. Date: Dec. 11, 2008

(54) METHOD OF MANUFACTURING LOWER PANEL FOR PLASMA DISPLAY PANEL USING X-RAYS

(75) Inventors: DONG-YOL YANG, Daejeon (KR); Seung-Min Ryu, Daejeon (KR); Suk-Hee Park, Daejeon (KR); Jong-seo Choi, Suwon (KR); Kwi-Seok Choi, Suwon (KR); Beom-wook Lee, Suwon (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/872,986

(22) Filed: Oct. 16, 2007

(30) Foreign Application Priority Data
Dec. 29, 2006 (KR) 2006-138906
Dec. 29, 2006 (KR) 2006-138907

(51) Int. Cl. H01J 17/49; H01J 9/02

(52) U.S. Cl. 313/582; 445/24

(57) ABSTRACT

A method of manufacturing a lower panel for a plasma display panel using X-rays which includes preparing a base substrate; forming a barrier rib material layer on the base substrate; defining barrier rib patterns by scanning X-rays on the barrier rib material layer; and developing the barrier rib material layer to form barrier ribs. Fine-pitch patterning of the barrier ribs can be achieved with high precision by using X-rays.

### CROSS-REFERENCE TO RELATED PATENT APPLICATIONS

This application claims the benefits of Korean Patent Application No. 2006-138906 and Korean Patent Application No. 2006-138907, both filed Dec. 29, 2006 in the Korean Intellectual Property Office, the disclosures of which are incorporated herein by reference.

### BACKGROUND OF THE INVENTION

1. Field of the Invention

Aspects of the present invention relate to a method of manufacturing a lower panel for a plasma display panel, and more particularly, to a method of manufacturing a lower panel for a plasma display panel in which fine-pitch patterning of barrier ribs can be achieved with high precision.

2. Description of the Related Art

Plasma display panels (PDPs) are flat panel display apparatuses that create images by exciting phosphors using ultraviolet (UV) light generated when a discharge occurs between sustain electrodes formed between an upper substrate and a lower substrate.

FIG. 1 is a schematic view illustrating a conventional alternating-current (AC) driving type surface-discharging PDP. Referring to FIG. 1, a plurality of address electrodes 22 and a lower dielectric layer 21 are disposed on a lower substrate 20 such that the address electrodes 22 are buried in the lower dielectric layer 21. Barrier ribs 24 define a plurality of discharge spaces G disposed on the lower dielectric layer 21 and define the discharge spaces G as individual emission areas. The discharge spaces G are coated with red, green, and blue (RGB) phosphors 25. The RGB phosphors 25 are excited by UV light generated by a plasma discharge to generate visible light, and the RGB phosphors 25 are arranged in the discharge spaces G and manipulated to create static or dynamic images.

An upper dielectric layer 11 and a protection layer 15 are disposed on an upper substrate 10 to cover scan and sustain electrode pairs 16 arranged on the upper substrate 10. The upper dielectric layer 11 accumulates wall charges upon the plasma discharge, and the protection layer 15 protects the sustain electrode pairs 16 and the upper dielectric layer 11 from sputtering by gaseous ions upon the plasma discharge, and at the same time, increases the emission efficiency of secondary electrons. An inert gas, such as He, Xe, or Ne, fills the discharge spaces G of the PDP at a pressure of about 400 to 600 Torr.

The barrier ribs 24 may be formed in an open type strip pattern, as illustrated in FIG. 1, or in a closed type pattern for the sake of a more efficient discharge. The barrier ribs 24 serve to maintain a predetermined distance between the upper substrate 10 and the lower substrate 20 and to define the discharge spaces G. The barrier ribs 24 prevent an electrical or optical cross-talk between the discharge spaces G so as to enhance image quality (including color purity) and provide an area for coating the phosphors 25 so as to contribute to the emission brightness of the PDP. Meanwhile, the barrier ribs 24 determine the size of pixels, which are the smallest units of images composed of the discharge spaces G having an RGB format, and determine the resolution of images by defining a cell pitch between the discharge spaces G. Thus, the barrier ribs 24 affect image quality and emission efficiency. As panels increase in size and provide higher definition images, much research into barrier ribs has been conducted.

Generally, barrier ribs are manufactured by screen printing, sandblasting, etching, photolithography using a photosensitive paste, or the like. Among them, photolithography using a photosensitive paste is performed as follows. First, a photosensitive paste containing a ceramic barrier rib material is coated on a substrate and dried to obtain a film having a desired thickness. Then, the photosensitive paste is selectively exposed to UV light through an aligned photomask and developed using a developer to remove uncured portions. Finally, the resultant structure is sintered to thereby complete the barrier ribs. During the exposure to UV light, a portion of the photosensitive paste exposed to UV light is cured through a polymerization reaction to form the barrier ribs, whereas the remaining portion of the photosensitive paste, as shielded by the photomask, is not cured but is decomposed and removed during the development.

The photosensitive paste may include inorganic microparticles and organic materials. UV light may be scattered at interfaces between the inorganic microparticles and the organic materials, and thus, photocuring may occur in a photosensitive paste portion adjacent to the target photosensitive paste portion. Moreover, due to light scattering occurring along the optical path of the UV light, the amount of the UV light supplied to a near-bottom portion of the photosensitive paste (or the portion of the photosensitive paste nearest the lower dielectric layer 21 in FIG. 1) may be insufficient to cure the near-bottom portion of the photosensitive paste. As such, the barrier ribs 24 are wider at the bottom than at the top as shown in FIG. 1. When increasing the intensity of the UV light in order to increase the penetration depth of UV light, the intensity of scattered light is also increased.

### SUMMARY OF THE INVENTION

Aspects of the present invention provide a method of manufacturing a lower panel for a plasma display panel (PDP), in which fine-pitch patterning of barrier ribs can be achieved with high precision using X-rays.

According to an aspect of the present invention there is provided a method of manufacturing a lower panel for a PDP, the method including: preparing a base substrate; forming a barrier rib material layer on the base substrate; defining barrier rib patterns by scanning X-rays on the barrier rib material layer; and developing the barrier rib material layer to form barrier ribs.

According to another aspect of the present invention, there is provided a method of manufacturing a lower panel for a PDP, the method including: forming a first barrier rib material layer to a first thickness on a base substrate; defining first barrier rib patterns by scanning X-rays on the first barrier rib material layer; forming a second barrier rib material layer to a second thickness on the first barrier rib material layer; defining second barrier rib patterns by scanning X-rays on the first and second barrier rib material layers; and developing the first and second barrier rib material layers to form barrier ribs having different heights.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view illustrating a conventional plasma display panel (PDP);

FIG. 2 is a flowchart illustrating a method of manufacturing a lower panel for a PDP according to aspects of the present invention;

FIGS. 3A through 3E are vertical sectional views illustrating detailed processes of the method of FIG. 2;

FIG. 4 is a vertical sectional view illustrating barrier ribs manufactured using UV lithography as a comparative example of the present invention;

FIG. 5 is an image showing barrier rib patterns manufactured using the method according to the method illustrated in FIG. 2;

FIGS. 6A through 6C are images showing barrier ribs manufactured under different exposure conditions;

FIGS. 7A through 7D are perspective views illustrating a method of manufacturing a lower panel for a PDP according to aspects of the present invention;

FIG. 8 is a perspective view illustrating an example of a lower panel manufactured according to the method of FIGS. 7A through 7D;

FIG. 9 is an image showing barrier rib patterns manufactured using the method according to aspects of the present invention;

FIG. 10 is a view illustrating a method of manufacturing a lower panel according to aspects of the present invention; and

FIGS. 11A through 11D are views illustrating a method of manufacturing a lower panel for a PDP according to aspects of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures. Aspects of the present invention may, however, be embodied in different forms and should not be construed as limited to the embodiments set forth herein. When it is mentioned that a layer or an electrode is said to be “disposed on” or “formed on” another layer or a substrate, the phrases mean that the layer or electrode may be directly formed on the other layer or substrate, or that a third layer may be disposed therebetween. In addition, the thickness of layers and regions may be exaggerated for clarity.

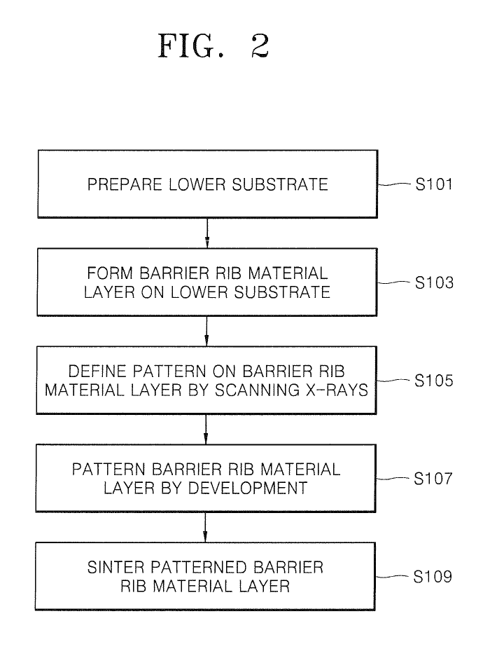

FIG. 2 is a flowchart illustrating a method of manufacturing a lower panel for a plasma display panel (PDP) according to aspects of the present invention. Referring to FIG. 2, the method of manufacturing the lower panel for the PDP according to aspects of the present invention is as herein described. First, a lower substrate for a PDP is prepared (S101), a barrier rib material layer is formed to a desired thickness on the lower substrate (S103), and X-rays are scanned on the barrier rib material layer to define a barrier rib pattern (S105). Then, the barrier rib material layer is developed and patterned (S107). Finally, the resultant structure is sintered (S109) to thereby complete a lower panel for a PDP.

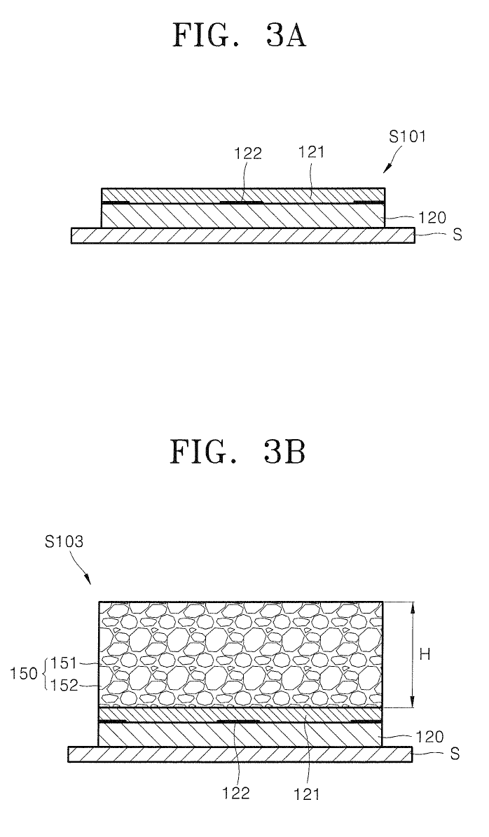

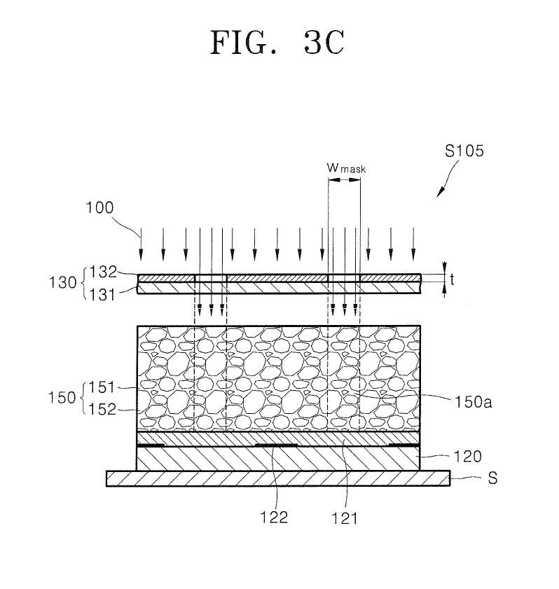

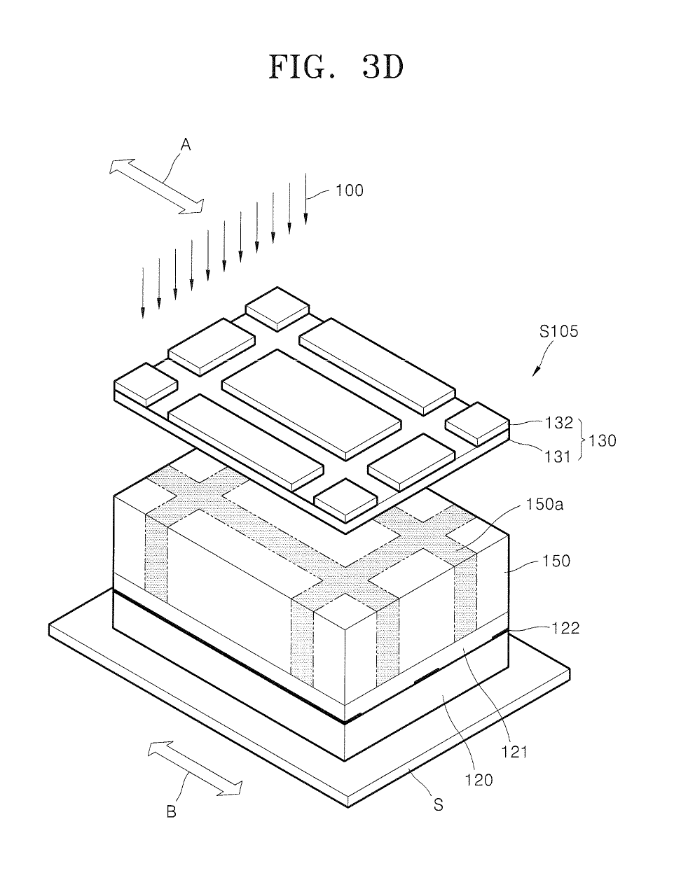

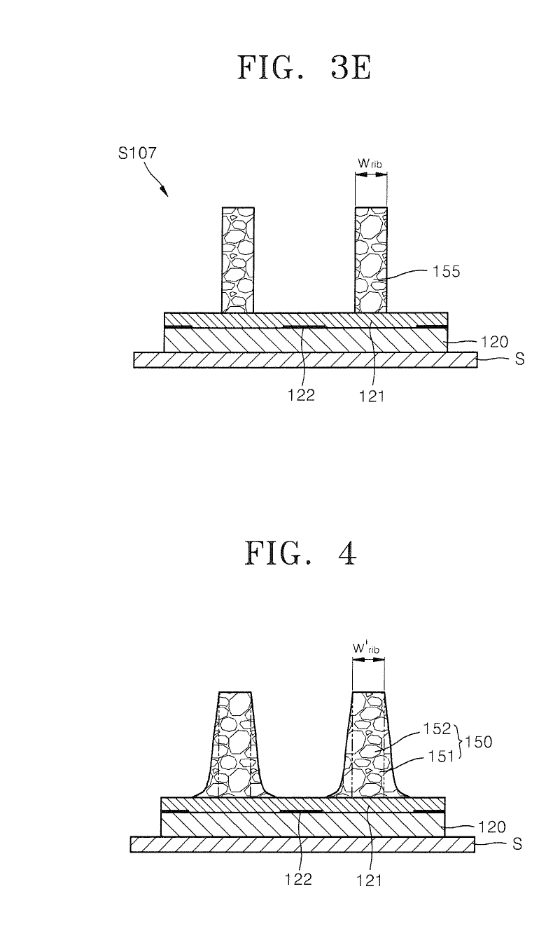

Hereinafter, the above-described operations will be sequentially described in more detail. FIGS. 3A through 3E are schematic process views illustrating the above-described operations. First, referring to FIG. 3A, a previously prepared lower substrate 120 for the PDP is disposed on a stage S. The lower substrate 120 may be a glass substrate made of a glass material or a flexible substrate made of a flexible plastic material. At this time, a plurality of electrodes 122 may be arranged on the lower substrate 120 as shown, but can be arranged at another time in other aspects. A dielectric layer 121 is disposed on the lower substrate 120 to cover the electrodes 122. The electrodes 122 are arranged to be parallel to each other and to be separated from each other by a predetermined distance in such a manner that they correspond to regions in which discharge spaces are to be formed. The dielectric layer 121 may be formed by wholly coating a dielectric paste on the lower substrate 120 covering the electrodes 122 but is not limited thereto. The electrodes 122 and/or the dielectric layer 121 may be omitted according to the desired structure of the PDP. For example, in a PDP structure including no address electrodes, both the electrodes 122 and the dielectric layer 121 may be omitted or constructed using other methods.

Barrier rib patterns are formed on the lower substrate 120 prepared as described above using X-rays. Hereinafter, a method of forming barrier rib patterns using X-ray lithography will be described. First, referring to FIG. 3B, a barrier rib material layer 150 is formed to a thickness H on the lower substrate 120 on which the electrodes 122 and the dielectric layer 121 are formed. The thickness H is relative to a top of the dielectric layer 121. The barrier rib material layer 150 may be formed of a material that exhibits a developing property or develops in response to X-rays (e.g., a material that can be optically or thermally cured by X-rays or dried during evaporation) and thus, can be patterned by development. Moreover, the barrier rib material layer 150 may be formed by coating a barrier rib material of a paste phase on the lower substrate 120 (or on the dielectric layer 121 as shown), or alternatively, laminating a barrier rib material of a sheet form on the lower substrate 120.

For example, the barrier rib material layer 150 may be formed of a photo-curable organic-inorganic composite material including inorganic microparticles 152, which are fundamental glass materials that will be sintered to form barrier ribs, and various organic materials 151. In more detail, the inorganic microparticles 152 may be composed of glass frit powder, and the organic materials 151 may include a vehicle for making the inorganic microparticles 152 into a paste phase, a binder for binding the inorganic microparticles 152, a photoinitiator for facilitating curing through a photochemical reaction, etc. In addition, the organic materials 151 may include a monomer, a dispersant, or other like materials.

The thickness H of the barrier rib material layer 150 corresponds to the height of barrier ribs to be formed. Thus, it is preferred that the barrier rib material layer 150 should be formed to a sufficient thickness. For example, taking into consideration the shrinkage of the barrier ribs after sintering, if the barrier rib material layer 150 is formed to a thickness of 160 to 180 μm before sintering, it is possible to obtain barrier ribs having a height of 120 to 130 μm after sintering. After forming the barrier rib material layer 150 to a desired thickness, the barrier rib material layer 150 is cured by drying. The drying of the barrier rib material layer 150 is needed when the barrier rib material layer 150 is formed of a barrier rib material in a paste phase. Thus, when an additional process for stabilizing the shapes of the barrier ribs is not needed, e.g., when the barrier rib material layer 150 is formed of a barrier rib material in a sheet form, the drying of the barrier rib material layer 150 may be omitted.

Next, referring to FIG. 3C, an X-ray mask 130 having a predetermined pattern is disposed above the barrier rib material layer 150. At this time, the X-ray mask 130 and the lower substrate 120, having the barrier rib material layer 150 disposed thereon, are aligned vertically with respect to each other. The X-ray mask 130 is divided into transmission regions Wmask and shielding regions. When the X-ray mask 130 comprises a transparent substrate 131 and an absorber 132, as shown in FIG. 3c, the absorber 132 is uniformly patterned on at least a surface of the transparent substrate 131. As such, the transmission regions Wmask correspond to portions of the transparent substrate 131 that are not covered with the absorber 132, and the shielding regions correspond to portions of the transparent substrate 131 that are covered with the absorber 132. Portions (illustrated as 150a) of the barrier rib material layer 150 corresponding to the transmission regions Wmask are intended to form barrier ribs 155 after photo-curing, and portions of the barrier rib material layer 150 corresponding to the shielding regions are uncured and later removed. Here, the transparent substrate 131 may be made of a material having good transmittance so that X-rays 100 of a strong intensity can be transmitted through the transmission regions Wmask. For this, the transparent substrate 131 may be made of a lower atomic number material so that it has a lower absorptivity. For example, in order to manufacture a large-scale mask, the transparent substrate 131 may be a hard glass substrate or a flexible polyimide film. Meanwhile, the absorber 132 may be formed to a thickness, e.g., a predetermined thickness t, so that light transmission through the shielding regions does not occur. The absorber 132 may be made of a higher atomic number material, e.g., gold (Au) or tungsten (W), in order to increase absorptivity. The absorber 132 disposed on a surface of the transparent substrate 131 may be patterned using photolithography or electroplating. Although the X-ray mask 130, the transparent substrate 131, and the absorber 132 are described with respect to X-rays, the X-ray mask 130, the transparent substrate 131, and the absorber 132 are not limited thereto such that any form of electromagnetic radiation may be used to pattern the barrier rib material layer 150. For example, the transparent substrate 131 may be transparent to higher energy electromagnetic radiation and the absorber 132 may block the transmission thereof.

Next, the X-rays 100 are scanned on the barrier rib material layer 150 through the X-ray mask 130 to define desired patterns on the barrier rib material layer 150. This operation can be explained in more detail with reference to FIG. 3D. That is, the X-rays 100 may be scanned while an X-ray source (not shown) emitting the X-rays 100 is moved in one direction (arrow A) in a state wherein the X-ray mask 130 and the lower substrate 120 are aligned. Alternatively, the X-rays 100 may be scanned from a fixed X-ray source (not shown) while the X-ray mask 130 and the stage S supporting the lower substrate 120 are moved in one direction (arrow B). An optimal method can be selected in consideration of convenience and can involve movement of both the X-ray source and the stage S. However, the two methods are the same in terms that the X-rays 100 are scanned from a side to the opposite side of the barrier rib material layer 150 while the X-rays 100 and the barrier rib material layer 150 are moved with respect to each other. Portions 150a of the barrier rib material layer 150 exposed to the X-rays 100 are cured through a polymerization reaction and left during development to thereby form barrier ribs 155. In contrast, portions of the barrier ribs material layer 150 which are not exposed to the X-rays 100 do not cure and are removed during development to thereby define discharge spaces. Generally, the X-rays 100 used in pattern definition may have a wavelength of 0.01 to 100 Å but are not limited thereto.

After the above-described pattern definition occurs, development is performed. During the development process, an appropriate developer (e.g., an alkaline solution) is applied to the barrier rib material layer 150 to selectively dissolve, disperse, and remove uncured portions of the barrier rib material layer 150. After the development is completed, only the portions of the barrier rib material layer 150 that were exposed and cured by the X-rays 100 are left and form barrier ribs 155, as illustrated in FIG. 3E.

As illustrated in FIGS. 3A through 3E, due to the optical characteristics of X-rays 100, barrier ribs 155 having a predetermined width Wrib can be formed to correspond to the transmission regions Wmask of the X-ray mask 130. As such, an advantage of the present invention is that fine-pitch barrier ribs having a uniform width, or a width that does not vary in the height direction, can be obtained.

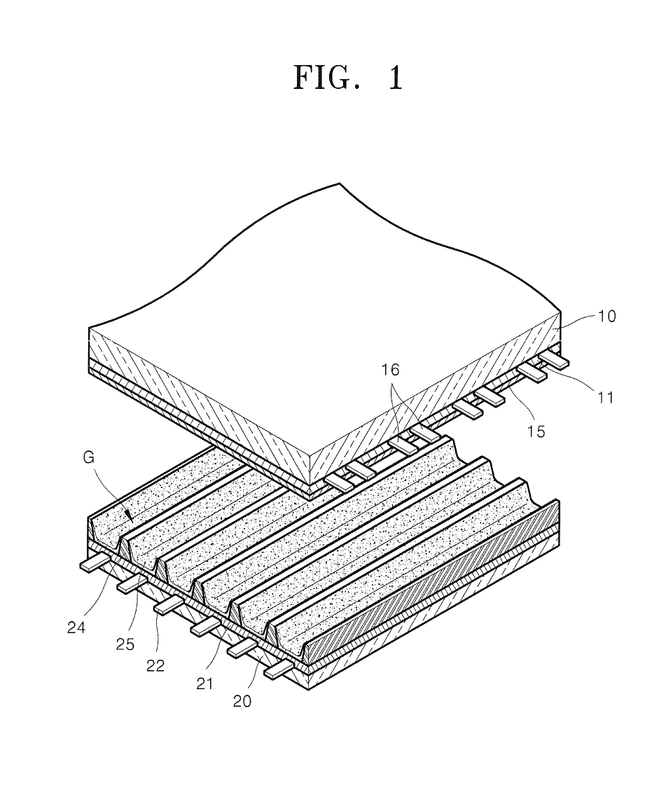

FIG. 4 is a sectional view illustrating barrier ribs patterned using UV light. Referring to FIG. 4, a barrier rib material layer 150 includes organic materials 151 and inorganic microparticles 152. While UV light irradiated on the barrier rib material layer 150 passes through the barrier rib material layer 150, it is scattered at a wide angle at interfaces of the inorganic microparticles 152 and is then diffused beyond desired barrier rib material layer portions into portions of the barrier rib material layer 150 adjacent to the desired barrier rib material layer portions. The portions of the barrier rib material layer 150 exposed to the scattered light may be undesirably cured. That is, portions of the barrier rib material layer 150 corresponding to shielding regions of a mask may also be exposed to UV light. For this reason, the width W′ rib of barrier ribs is not uniform in the height direction, but gradually increases along the optical path of the UV light, i.e., the barrier rib layer material 150 cures to form, with reference to FIG. 1, barrier ribs 24 having an increasing width in a direction from the upper substrate 10 to the lower substrate 20.

In addition, the amount of the UV light continuously decreases along the optical path of the UV light due to light being scattered along the optical path. As a result, an insufficient amount of the UV light may be supplied in a near-bottom portion of the barrier rib material layer 150 closest to the substrate 120 of FIG. 4. In view of such problem, when increasing the intensity of the UV light, the intensity of the scattering is also increased, and thus, portions of the barrier rib material layer 150 corresponding to shielding regions of a mask are increasingly exposed to the UV light. In contrast, according to aspects of the present invention, X-rays showing less scattering characteristics at the interfaces of inorganic microparticles are used, and thus, it is possible to prevent the occurrence of uncontrollable exposure due to light scattering. Therefore, it is possible to precisely manufacture barrier rib patterns having a uniform width corresponding to transmission regions of a mask.

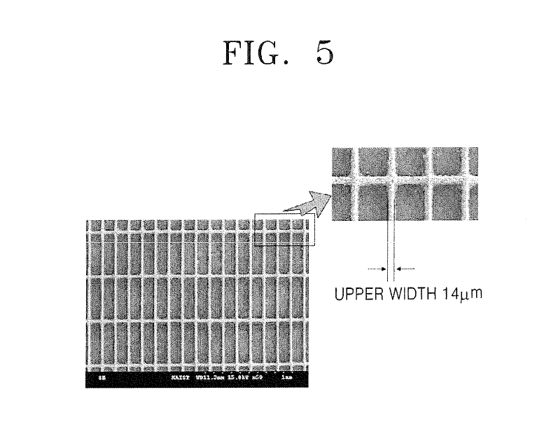

X-rays having a short wavelength as used according to aspects of the present invention have a good transmittance which is sufficient to pass through a barrier rib material layer having a thick thickness, and thus, can penetrate to reach a bottom of the barrier rib material layer. Thus, according to aspects of the present invention, the limitation to the thickness of a barrier rib material layer that is determined according to the transmittance of a used light can be overcome. Moreover, by forming a barrier rib material layer to a thick thickness when needed, it is possible to easily manufacture barrier ribs with a high aspect ratio (i.e., where the ratio of the height of the barrier ribs to the width of the barrier ribs is high). In addition, a refraction phenomenon caused by a refractive index difference between organic materials and inorganic microparticles can be reduced due to the high penetration of X-rays, and thus, precision of light directionality is enhanced to thereby enable the fine-pitch patterning of barrier ribs. FIG. 5 shows fine-pitch barrier ribs patterned using X-rays, in which an upper width of the barrier ribs is about 14 μm.

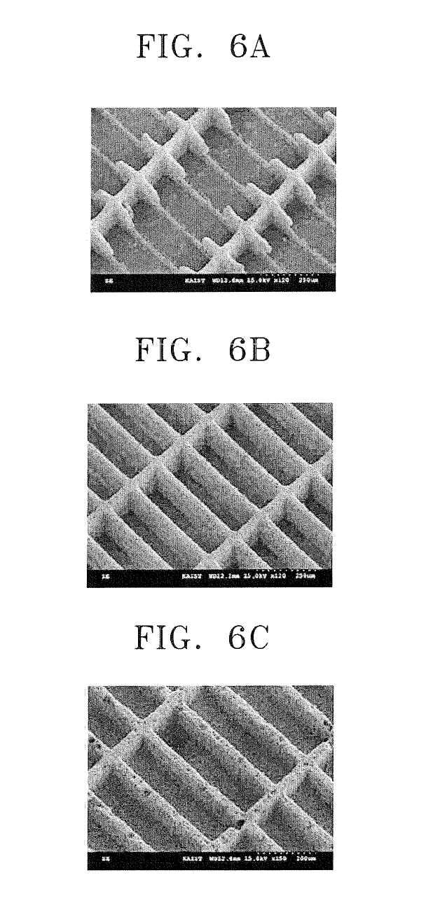

The amount of energy per unit volume (exposure dose, unit: kJ/cm³) absorbed in a barrier rib material layer is closely related to the precision of a finally obtained barrier rib structure. Thus, in exposing the barrier rib material layer to the X-rays according to aspects of the present invention, it is preferable (but not required) to accurately control the dose of the X-rays applied to a barrier rib material layer through a quantitative calculation. The dose of the X-rays applied to the barrier rib material layer can be optimized by controlling exposure conditions (e.g., the intensity of the X-rays, an exposure time) considering the penetration depth of the X-rays and the X-ray absorptivity of the barrier rib material layer. FIGS. 6A through 6C are images showing barrier ribs manufactured under different exposure conditions. If an exposure time is too short, barrier ribs are not properly formed as the barrier rib material layer is insufficiently cured due to lack of exposure, as illustrated in FIG. 6A. In contrast, if an exposure time is too long, as illustrated in FIG. 6C, defects (e.g., cavities or cracks) are generated in the resultant barrier ribs, and portions of a barrier rib material layer corresponding to the shielding regions of an X-ray mask are also exposed to X-rays, thereby leading to the curing of the portions of the barrier rib material layer corresponding to the shielding regions of the X-ray mask. However, barrier ribs manufactured by an appropriate exposure duration have smooth surfaces, as illustrated in FIG. 6B.

Referring again to FIGS. 3A through 3E, barrier rib material layer patterns obtained by the above-described pattern definition and development are sintered. For this, the barrier rib material layer patterns are heated at a high temperature near the melting point of the inorganic microparticles 152 (e.g., frit glass) contained in the barrier rib material layer patterns so that the inorganic microparticles 152 are fused and sintered, and at the same time, the organic materials 151 contained in the barrier rib material layer patterns are removed.

According to aspects of the present invention, the formation of barrier ribs using X-ray lithography has been illustrated. However, provided that a barrier rib material layer can be patterned using X-rays, an X-ray based method for the formation of barrier ribs is not limited to the above, and the technical principles can be applied to various methods according to aspects of the present invention. For example, the optical path of X-rays can be controlled according to barrier rib patterns instead of using an exposure mask. By doing so, desired patterns can be defined on a barrier rib material layer. This can be realized by operating an X-ray gun with an X-Y table capable of moving in biaxial directions.

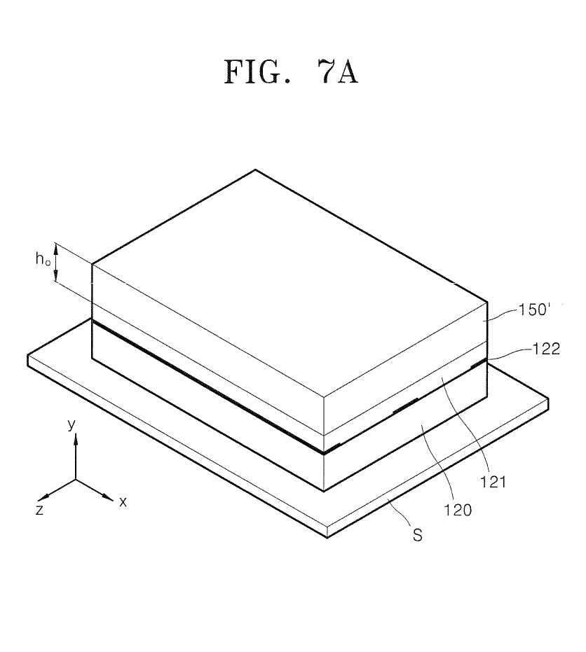

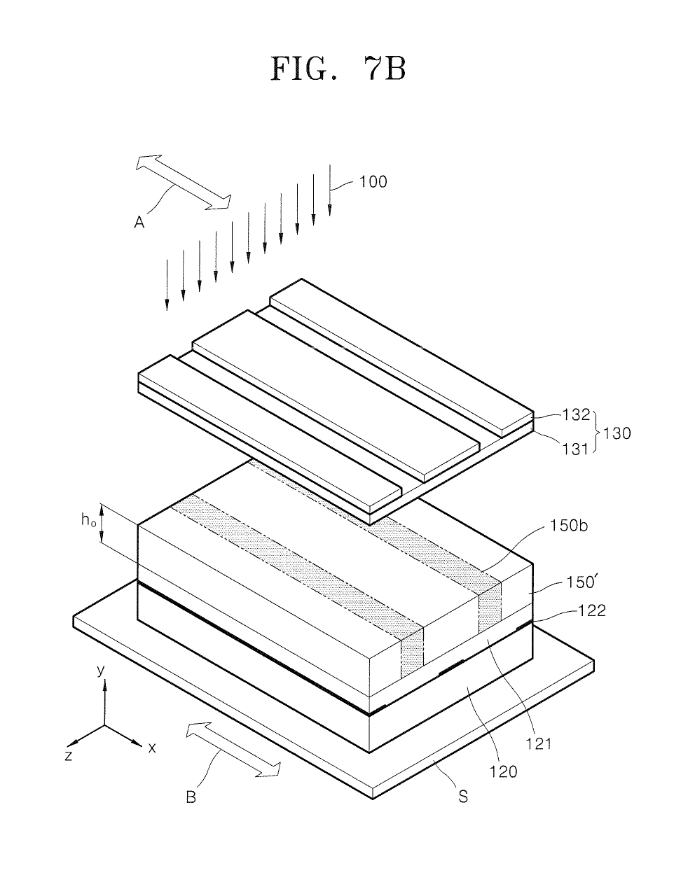

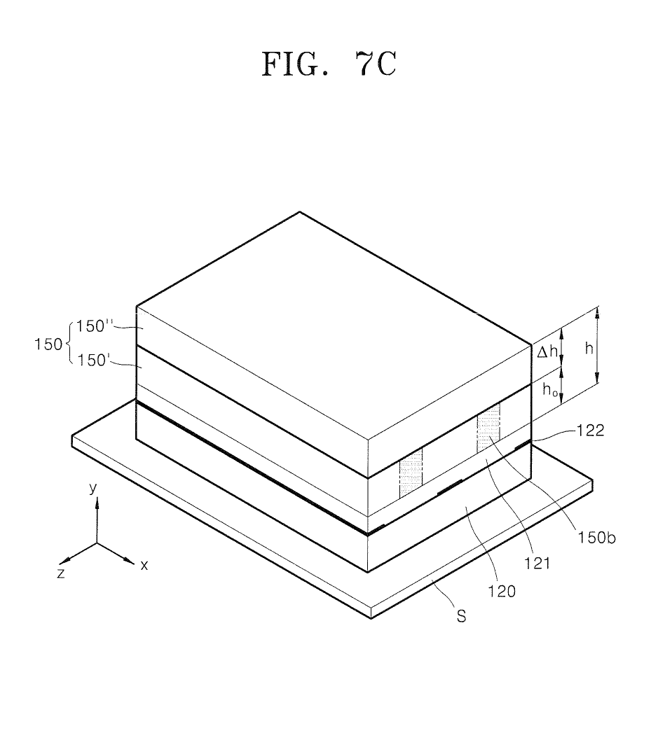

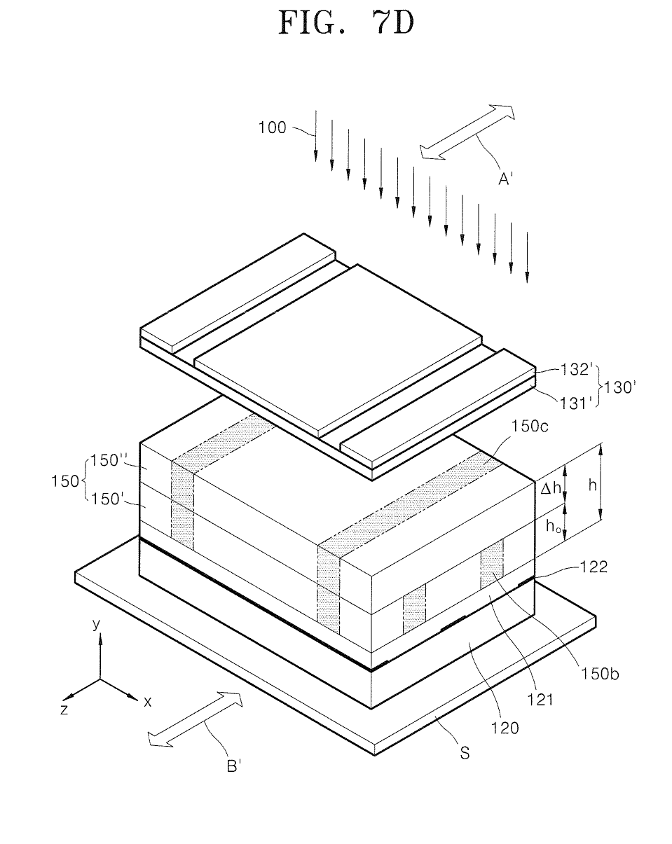

FIGS. 7A through 7D are perspective views illustrating a method of manufacturing a lower panel for a PDP according to aspects of the present invention. As described above, desired patterns are defined on a barrier rib material layer using X-rays, but the so-called stepped barrier rib patterns, barrier ribs in which different portions of the barrier ribs have different heights, are formed using two operations: a first pattern definition and a second pattern definition.

Hereinafter, aspects of the present invention will be described in more detail. First, referring to FIG. 7A, a previously prepared lower substrate 120 for the PDP is disposed on a stage S. At this time, a plurality of electrodes 122 and a dielectric layer 121 disposed to cover the electrodes 122 are formed on the lower substrate 120 but need not be limited thereto. Then, a first barrier rib material layer 150′ is formed on the lower substrate 120. For example, the first barrier rib material layer 150′ may be formed by coating a photosensitive paste including inorganic microparticles and various functional organic materials to a predetermined thickness hₒ. Here, the thickness hₒ of the first barrier rib material layer 150′ corresponds to the height of first barrier ribs that have a relatively lower height among the stepped barrier ribs to be formed. Then, the first barrier rib material layer 150′ is dried. The drying of the first barrier rib material layer 150′ may be omitted according to the physical properties of a material of the first barrier rib material layer 150′. For example, if a barrier rib material sheet is attached to a lower substrate, drying is not needed.

Next, referring to FIG. 7B, an X-ray mask 130 having a predetermined pattern is aligned above the lower substrate 120 on which the first barrier rib material layer 150′ is formed. The X-ray mask 130 may be a mask in which an absorber 132 is patterned on a surface of a transparent substrate 131. Here, the absorber 132 defines shielding regions that shield X-rays, and portions of the transparent substrate 131 which are not covered with the absorber 132 define transmission regions that transmit X-rays. The X-ray mask 130 may be designed to have transmission regions that are strip-patterned in one direction (e.g., an x-axis direction).

Then, desired patterns are defined on the first barrier rib material layer 150′ using the X-ray mask 130 (a first pattern definition). At this time, portions 150b of the first barrier rib material layer 150′ corresponding to the transmission regions of the X-ray mask 130 are exposed to X-rays 100 and cured through a polymerization reaction. Portions of the first barrier rib material layer 150′ corresponding to the shielding regions of the X-ray mask 130 are not cured. Meanwhile, in this operation, the X-rays 100 may be scanned while an X-ray source (not shown) that emits the X-rays 100 is moved in one direction (e.g., in an x-axis direction, or arrow A) in a state wherein the X-ray mask 130 and the lower substrate 120 are fixedly aligned, or alternatively, the X-rays 100 may be scanned from a fixed X-ray source (not shown) while the X-ray mask 130 and the stage S supporting the lower substrate 120 are moved in one direction (e.g., in an x-axis direction, or arrow B).

When the first pattern definition is completed as described above and as illustrated in FIG. 7C, a second barrier rib material layer 150″ is coated to a thickness Δh on the first barrier rib material layer 150′ having the thickness hₒ. Thus, a barrier rib material layer 150 including the first and second barrier rib material layers 150′ and 150″ is formed to a thickness h (hₒ+Δh) on the lower substrate 120. At this time, the thickness h of the barrier rib material layer 150 corresponds to the height of second barrier ribs that have a relatively higher height among the stepped barrier ribs. After forming the second barrier rib material layer 150″ as described above, the barrier rib material layer 150 may be dried if needed.

Next, referring to FIG. 7D, an X-ray mask 130′ is aligned above the barrier rib material layer 150. The X-ray mask 130′ may be a mask in which an absorber 132′ is patterned on a surface of a transparent substrate 131′. The X-ray mask 130′ may be designed to have transmission regions that are strip-patterned in one direction (e.g., in a z-axis direction). The transmission regions may extend to intersect with the transmission regions of the X-ray mask 130 used in the above-described first pattern definition.

Again, desired patterns are defined on the barrier rib material layer 150 using the X-ray mask 130′ (a second pattern definition). At this time, portions 150c of the barrier rib material layer 150 corresponding to the transmission regions of the X-ray mask 130′ are exposed to X-rays 100 and cured through a polymerization reaction. At this time, patterns cured by the second pattern definition may overlap with patterns cured by the first pattern definition. Meanwhile, in this operation, the X-rays 100 may be scanned while an X-ray source (not shown) emitting the X-rays 100 is moved in one direction (e.g., in a z-axis direction, or arrow A′) in a state wherein the X-ray mask 130′ and the lower substrate 120 are fixedly aligned, or alternatively, the X-rays 100 may be scanned from a fixed X-ray source (not shown) while the X-ray mask 130′ and the stage S supporting the lower substrate 120 are moved in one direction (e.g., in a z-axis direction, or arrow B′). Although the directions are described and illustrated as the x-axis and the z-axis directions, such the directions are not limited thereto such that the x-axis and z-axis directions need not be perpendicular but need only cross or extend to intersect. Further, a third and/or a fourth, etc., X-ray pattern definition processes may be applied to further define barrier ribs having different heights to obtain multi-stepped barrier ribs and barrier ribs of different patterns having different heights.

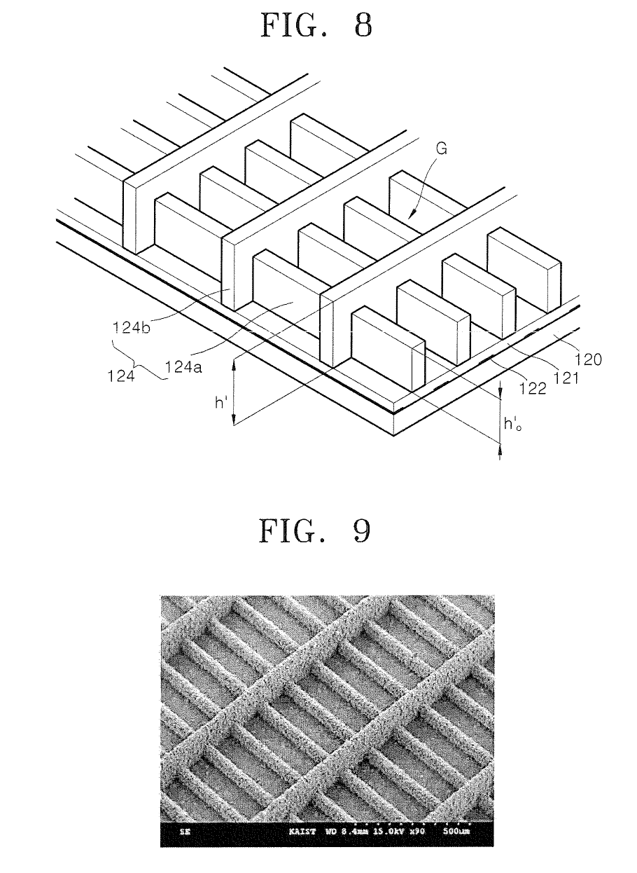

After performing the two-step X-ray pattern definition process as described above, the barrier rib material layer 150 is developed and sintered to thereby obtain stepped barrier ribs 124 as illustrated in FIG. 8. Referring to FIG. 8, the stepped barrier ribs 124 include first barrier ribs 124a and second barrier ribs 124b that extend to intersect with each other and have heights h′ₒ, and h′, respectively, so that the first barrier ribs 124a and the second barrier ribs 124b extend to different heights from the lower dielectric layer 121, which is disposed on the lower substrate 120 to cover the electrodes 122. FIG. 9 is an image showing stepped barrier rib patterns manufactured according to the above-described method.

According to aspects of the present invention, the formation of barrier ribs using X-ray lithography has been illustrated but is no limited thereto. For example, selective exposure can be achieved by setting the output of X-rays in a predetermined optical path. In more detail, a barrier rib material layer can be patterned using a driver guiding X-rays from an X-ray gun along a controlled path, e.g., using an X-Y table.

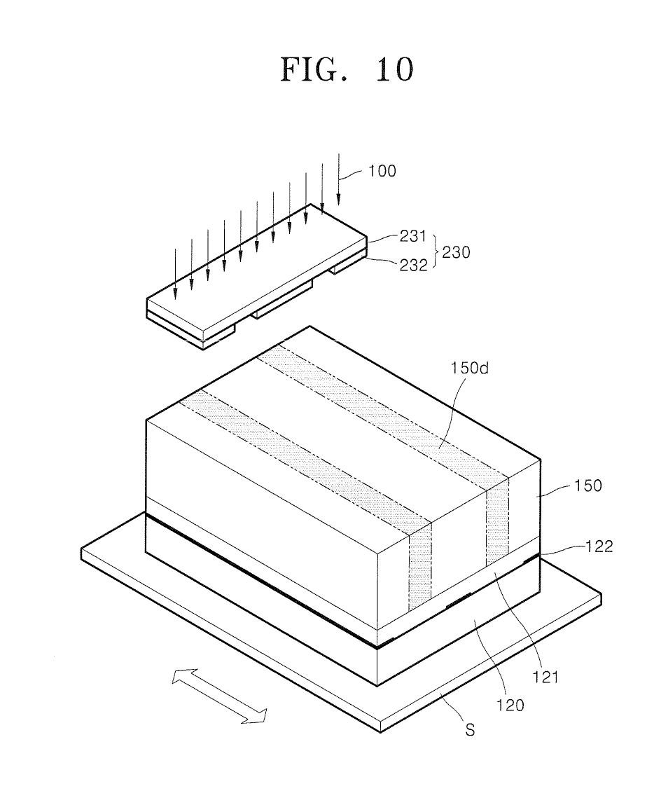

A method of manufacturing a lower panel for a PDP according to aspects of the present invention will now be described with reference to FIG. 10. According to aspects of the current invention in FIG. 10, an X-ray mask does not necessarily cover the entire area of a barrier rib material layer, but is placed in the optical path of X-rays and has a small area sufficient to cover only a portion of the barrier rib material layer under X-ray irradiation. That is, referring to FIG. 10, a lower substrate 120 coated with a barrier rib material layer 150 is disposed on a stage S that is installed movably in one direction, and an X-ray gun (not shown) and an X-ray mask 230 are fixedly installed above the stage S. At this time, the X-ray mask 230 may include a transparent substrate 231 and an absorber 232 attached to the transparent substrate 231 to define transmission regions and shielding regions. By placing the X-ray mask 230 in the optical path of X-rays 100, predetermined beams of the X-rays 100 can be scanned on the barrier rib material layer 150.

The X-rays 100 are scanned on the barrier rib material layer 150 via the X-ray mask 230 while the stage S, on which the lower substrate 120 is disposed, is moved so that the lower substrate 120 is moved at a predetermined speed in one direction. Thus, the barrier rib material layer 150 coated on the lower substrate 120 is gradually exposed to the X-rays 100 while it moves at the predetermined speed with respect to the fixed X-ray gun. That is, while the barrier rib material layer 150 is moved with respect to the X-rays 100 emitted from the fixed X-ray gun, the X-rays 100 are scanned from one side to an opposite side of the barrier rib material layer 150. At this time, the predetermined speed at which the stage S, containing the barrier rib material layer 150, moves corresponds to the scan rate of the X-rays 100 and determines the exposure dose of the X-rays 100 to the barrier rib material layer 150. Thus, it is preferable to optimize the predetermined speed at which the stage S, containing the barrier rib material layer 150, moves considering the penetration depth of the X-rays 100 and X-ray absorptivity of the barrier rib material layer 150. For example, when the barrier rib material layer 150 is formed of a negative type material, portions 150d of the barrier rib material layer 150 exposed to the X-rays 100 are cured through a polymerization reaction. The exposed portions 150d of the barrier rib material layer 150 are left during development to finally form barrier ribs.

According to aspects of the present invention, an X-ray mask is formed to have an area that covers at least the optical path of X-rays and is smaller than the area of a barrier rib material layer. Thus, a reduction in mask manufacturing costs can be achieved while acquiring the same exposure effects as described above. As a result, manufacturing costs of PDPs are reduced, thereby enhancing cost and price competitiveness. In particular, for large-scale (e.g., 40-inch or more) displays, a great cost reduction is realized.

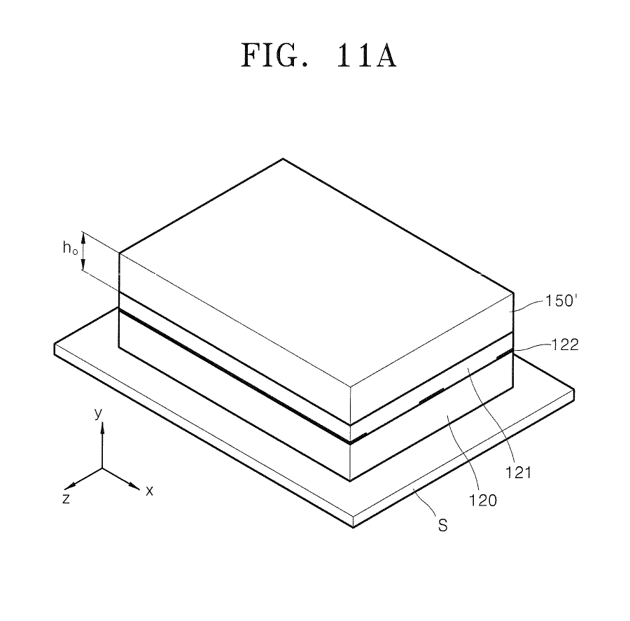

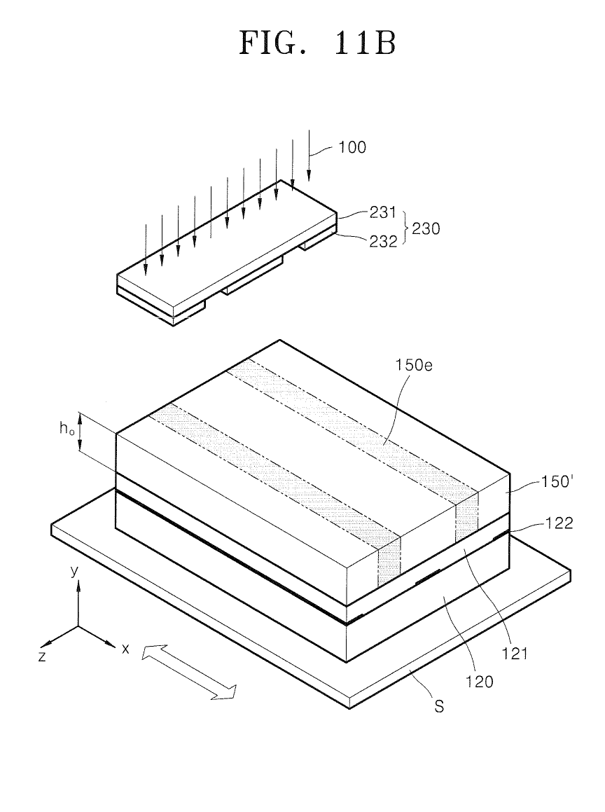

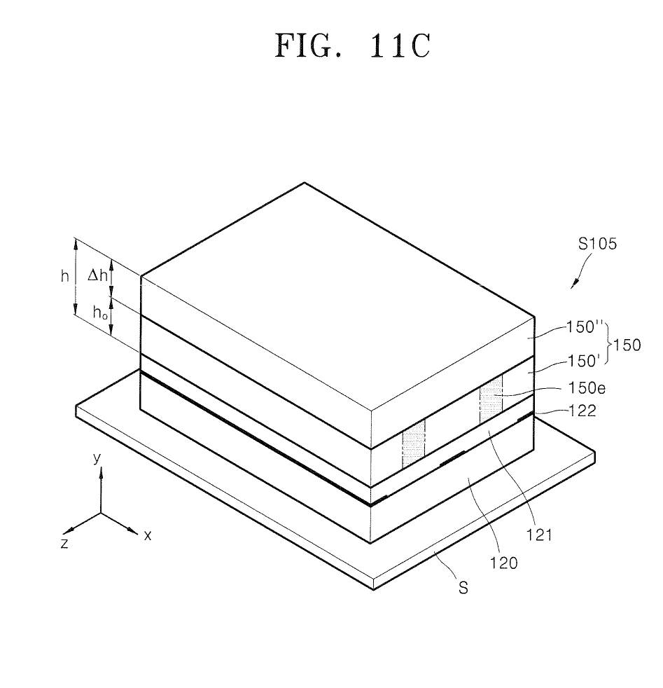

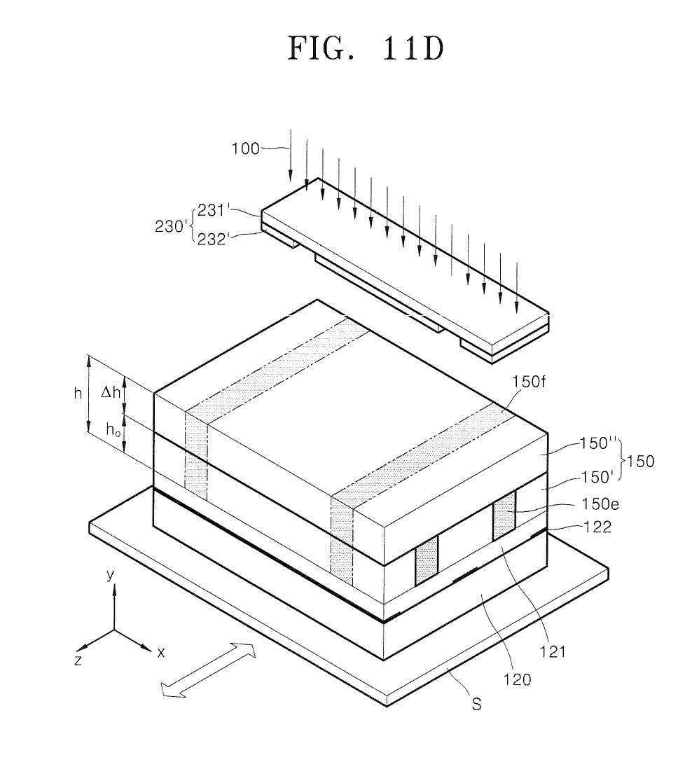

FIGS. 11A through 11D are process views illustrating a method of manufacturing a lower panel for a PDP according to aspects of the present invention. Aspects of the present invention shown in FIGS. 11A through 11D further provide a method of forming stepped barrier rib patterns using two operations, i.e., first pattern definition and second pattern definition. Moreover, according to aspects of the present invention shown in FIGS. 11A through 11D, multiple pattern definitions are performed using smaller X-ray masks to thereby reduce mask manufacturing costs.

First, referring to FIG. 11A, a previously prepared lower substrate 120 for a PDP is disposed on a stage S, and a first barrier rib material layer 150′ is coated to a thick thickness hₒ on the lower substrate 120. Here, the thickness hₒ of the first barrier rib material layer 150′ corresponds to the height of first barrier ribs that have a relatively lower height among the stepped barrier ribs to be formed. The first barrier rib material layer 150′ may be selectively dried.

Next, referring to FIG. 11B, an X-ray mask 230 is prepared and placed in the optical path of X-rays 100. The X-ray mask 230 may include a transparent substrate 231 and an absorber 232 to define transmission regions and shielding regions, respectively, and the transmission regions of the X-ray mask 230 may be designed to extend in one direction (e.g., in an x-axis direction as shown). The X-ray mask 230 is placed in the optical path of the X-rays 100 and has a small area to cover only a portion of the first barrier rib material layer 150′ that may be potentially exposed to the X-rays 100. Thus, the manufacturing costs of the X-ray mask 230 can be reduced, thereby lowering the manufacturing costs of PDPs and increasing the price competitiveness of the PDPs.

Next, desired patterns are defined on the first barrier rib material layer 150′ using the X-ray mask 230 (a first pattern definition). That is, the lower substrate 120 coated with the first barrier rib material layer 150′ is disposed on the stage S, and an X-ray gun (not shown) and the X-ray mask 230 are fixedly disposed above the stage S. At this time, the X-ray mask 230 is placed in the optical path of the X-rays 100. The X-rays 100 are scanned while the stage S, which supports the lower substrate 120, is moved such that the lower substrate 120 is moved at a predetermined speed in one direction (e.g., in an x-axis direction). Here, the movement direction of the lower substrate 120 is parallel to an extending direction (e.g., an x-axis direction) of the transmission regions of the X-ray mask 230. While the first barrier rib material layer 150′ is moved at a predetermined speed with respect to the X-rays 100 emitted from a fixed X-ray source (not shown), the X-rays 100 are scanned from one side to the opposite side of the first barrier rib material layer 150′. As the X-rays 100 are scanned, portions 150e of the first barrier rib material layer 150′ corresponding to the transmission regions of the X-ray mask 230 are exposed to the X-rays 100 and cured through a polymerization reaction. Portions of the first barrier rib material layer 150′ corresponding to the shielding regions of the X-ray mask 230 are originally maintained until after a second pattern definition process is performed.

After the first pattern definition process is completed, a second barrier rib material layer 150″ is coated to a thickness Δh on the first barrier rib material layer 150′ having the thickness hₒ, as illustrated in FIG. 11C. Thus, a barrier rib material layer 150 including the first and second barrier rib material layers 150′ and 150″ is formed to a thickness h (hₒ+Δh) on the lower substrate 120. At this time, the thickness h of the barrier rib material layer 150 corresponds to the height of second barrier ribs that have a relatively higher height among the stepped barrier ribs. After forming the second barrier rib material layer 150″, the barrier rib material layer 150 may be dried.

Next, referring to FIG. 11D, an X-ray mask 230′ is prepared and placed in the optical path of X-rays 100. While not required in all aspects, the X-ray mask 230′ may include a transparent substrate 231′ and an absorber 232′ disposed on the transparent substrate 231′ to define transmission regions of the X-ray mask 230′ in one direction (e.g., in a z-axis direction as shown). The transmission regions of the X-ray mask 230′ may intersect with those of the X-ray mask 230 used in the first pattern definition process. The X-ray mask 230′ has a small area to cover only a portion of the barrier rib material layer 150 under X-ray irradiation or to mask the entire optical path of the X-ray radiation to thereby reduce mask manufacturing costs.

Next, desired patterns are defined on the barrier rib material layer 150 using the X-ray mask 230′. The lower substrate 120 supporting the barrier rib material layer 150 is disposed on the stage S that is installed movably in at least one direction (e.g., in a z-axis direction), and an X-ray gun (not shown) and the X-ray mask 230′ are fixedly installed above the lower substrate 120 and separated from the lower substrate 120 by a predetermined distance. At this time, the X-ray mask 230′ is aligned in the optical path of the X-rays 100. While the stage S on which the lower substrate 120 is disposed is operated in one direction (e.g., in a z-axis direction), the X-rays 100 are scanned on the barrier rib material layer 150. The X-rays 100 emitted from the fixed X-ray gun can be scanned from one side to the opposite side of the barrier rib material layer 150 while the barrier rib material layer 150 relatively moves with respect to the X-rays 100. As the X-rays 100 are scanned, portions 150f of the barrier rib material layer 150 exposed to the X-rays 100 are cured through a polymerization reaction. At this time, the portions 150f exposed and cured by the second pattern definition process may overlap with the portions 150e exposed and cured by the first pattern definition process.

When the barrier rib material layer 150 pattern-defined as described above is developed and sintered, inorganic microparticles of the barrier rib material layer 150 are fused with each other to finally form stepped barrier ribs (see 124 of FIG. 8). The stepped barrier ribs include first barrier ribs (see 124a in FIG. 8) and second barrier ribs (see 124b in FIG. 8) that extend to intersect each other and have different heights (see h′ₒ and h′ in FIG. 8), so that the first barrier ribs and the second barrier ribs are vertically stepped with respect to each other.

According to aspects of the present invention, a desired pattern can be accurately defined on a barrier rib material layer using X-rays having predetermined optical characteristics, and thus, fine-pitch and high-resolution patterning of barrier ribs can be achieved with high precision. Furthermore, X-rays used in pattern definition have a high penetration efficiency such that the x-rays are able to cure even the barrier rib material layer closest to the substrate. Thus, in order to manufacture barrier ribs with a high aspect ratio, it is possible to coat a photosensitive paste to a desired thick thickness with decreased process restrictions.

Furthermore according to aspects of the invention, X-rays show relatively low scattering characteristics in a barrier rib material containing two or more different components. Thus, when selecting a barrier rib material, it is not necessary to consider other optical characteristics (e.g., refractive index) of the barrier rib material, thereby reducing manufacturing costs, compared to conventional UV lithography using a special barrier rib material.

In addition, according to aspects of the present invention, when performing pattern definition using an X-ray mask, the size of the X-ray mask can be reduced based on the area of X-ray radiation, thereby reducing manufacturing costs and increasing price competitiveness. In particular, when manufacturing a large-scale (e.g., 40-inch or more) plasma display panel, the manufacturing costs can be significantly reduced.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of manufacturing a lower panel for a plasma display panel, the method including:
forming a barrier rib material layer on a prepared base substrate;
defining barrier rib patterns by scanning X-rays on the barrier rib material layer; and
developing the barrier rib material layer having the barrier rib patterns defined by the X-rays to form barrier ribs.

2. The method of claim 1, wherein the barrier rib material layer comprises a material that develops in response to the X-rays.

3. The method of claim 1, wherein the barrier rib material layer comprises inorganic microparticles and organic materials, the inorganic microparticles are fused by the X-rays to form the barrier ribs, and at least a part of the organic materials are removable by the X-rays.

4. The method of claim 1, wherein the forming of the barrier rib material layer further comprises coating a paste on the base substrate or laminating a sheet material on the base substrate.

5. The method of claim 1, further comprising, to prepare the base substrate, forming a plurality of electrodes on the base substrate.

6. The method of claim 5, further comprising, to prepare the base substrate, forming a dielectric layer, on which the barrier rib material layer is to be formed, to cover the plurality of electrodes.

7. The method of claim 1, further comprising drying the barrier rib material layer before the defining of the barrier rib patterns.

8. The method of claim 1, wherein the defining of the barrier rib patterns comprises placing a photomask having shielding regions and transmission regions in an optical path of the X-rays and exposing the photomask to the X-rays such that the shielding regions shield the barrier rib material layer from the X-rays, and the transmission regions allow the transmittance of the X-rays.

9. The method of claim 8, wherein the photomask has a small area sufficient to mask an entire optical path of the X-rays, the small area being smaller than the barrier rib material layer.

10. The method of claim 9, wherein an X-ray source that emits the X-rays and the photomask are disposed in predetermined positions, and the X-rays are scanned while the base substrate is moved in a scan direction.

11. The method of claim 8, wherein the X-rays move in a predetermined path to define the barrier rib patterns.

12. The method of claim 1, further comprising sintering the patterned barrier rib material layer.

13. The method of claim 1, wherein the X-rays have a wavelength of 0.01 to 100 Å.

14. The method of claim 1, wherein the developing further comprises removing portions of the barrier rib material layer not exposed to the scanning X-rays.

15. A method of manufacturing a lower panel for a plasma display panel, the method including:
forming a first barrier rib material layer of a first thickness on a base substrate;
defining a first barrier rib pattern by scanning X-rays on the first barrier rib material layer;
forming a second barrier rib material layer of a second thickness on the first barrier rib material layer;
defining a second barrier rib pattern by scanning X-rays on the first and second barrier rib material layers; and
developing the first and second barrier rib material layers having the first and second barrier rib patterns defined by the X-rays to form barrier ribs having different heights.

16. The method of claim 15, wherein the defining of the first barrier rib pattern and the defining of the second barrier rib pattern are performed using different photomasks.

17. The method of claim 15, wherein the first barrier rib pattern and the second barrier rib pattern extend in strips to intersect each other.

18. The method of claim 15, wherein the forming of the first barrier rib material layer further comprises coating a paste on the base substrate or laminating a sheet material on the base substrate, and the forming of the second barrier rib material layer further comprises coating a paste on the first barrier rib material layer or laminating a sheet material on the first barrier rib material layer.

19. The method of claim 15, further comprising preparing the base substrate, the base substrate comprising:
a lower substrate;
address electrodes formed to cross the lower substrate; and
a dielectric layer formed to cover the lower substrate and the address electrodes.

20. A plasma display panel, comprising:
an upper substrate and a lower substrate disposed to face each other at a predetermined distance;
barrier ribs disposed between the upper and lower substrates to define discharge cells; and
scan and sustain electrodes formed on the upper substrate to generate discharges in the discharge cells,
wherein a lower panel including at least the lower substrate and the barrier ribs is formed by the method of claim 1.
